(19) United States
(12) Patent Application Publication
(10) Pub. No.: US 2007/0049497 A1
(43) Pub. Date: Mar. 1, 2007

(54) Tablets for dispersing agricultural compounds

(76) Inventors: James Jeffrey Parker, Greenville, NC (US); Patrick Brian Woodall, Greenville, NC (US)

Correspondence Address: Womble Carlyle Sandridge & Rice, LLP, Ste. 3500, 1201 W. Peachtree St., NW, Atlanta, GA, 30309-3463, US

(21) Appl. No.: 11/442,087

(22) Filed: May 26, 2006

Related U.S. Application Data
(60) Provisional application No. 60/711,339, filed on Aug. 25, 2005.

(51) Int. Cl. A01N 25/00

(52) U.S. Cl. 504/358; 424/405

(57) ABSTRACT

Tablets which include agricultural compounds, and which can be readily dispersed in aqueous media, are disclosed. The tablets include small amounts of microcrystalline cellulose, one or more agricultural compounds which are solid at room temperature, and optionally include additional components such as wetting agents, surfactants, carriers, binders, flow agents, tableting lubricants, antifoam agents, and fillers. The compounds are preferably hydrophobic, such as hydrophobic pesticides. The microcrystalline cellulose has a particle size as close as possible to the initial particle size of the agricultural compound. The particle sizes of the agricultural compound and the microcrystalline cellulose are less than about 100 microns, preferably less than about 50 microns, and more preferably less that about 20 microns, and the particle sizes of both the agricultural compound and the microcrystalline cellulose range from 1:5 to 5:1 more preferably between 1:3 and 3:1, and still more preferably, between 1:2 to 2:1. Using the technology described herein, the tablets can include up to 70 percent by weight of the agricultural compound. In some embodiments, a blend of particle sizes for the microcrystalline cellulose, for example, a blend of relatively large and relatively small MCC particles is used. This embodiment tends to produce a mix that flows better in a tablet press and reduces the cost of production.

This application claims benefit of U.S. Provisional Patent Application No. 60/7110,339, filed Aug. 25, 2006, the contents of which are fully incorporated herein by reference.

### FIELD OF THE INVENTION

The application is generally in the area of tablet forms of agricultural chemicals, and methods for making and using the tablets, where the tablets disintegrate rapidly in aqueous solution.

### BACKGROUND OF THE INVENTION

Most farmers use a large number of agricultural chemicals, and therefore have a relatively high potential for exposure to toxic levels of these chemicals. Agricultural chemicals are often produced and sold in dry form, usually a water dispersible powder, as they might lose their potency more rapidly if stored in aqueous solution. Portions of such powered pesticides must be measured out and mixed with water prior to application. The act of measuring, transferring, and mixing these powders with water often produces airborne dust which can deposit high levels of the chemicals onto the person performing the work and can also produce respirable dust which can pose an even bigger danger. It would be advantageous to minimize this contact. In addition, measuring small amounts of high-potency pesticide powders can be difficult to perform accurately in the field and would benefit from a pre-measured “unit dose” afforded by a tablet.

In order to perform acceptably a tablet must disintegrate quickly, preferably in less than five minutes, and produce a fine dispersion of particles that are about the same size as present in the material before compression. Efforts have been made to store the compounds in tablet form, but the high compression used to form the tablets often results in tablets that do not adequately disperse in aqueous solutions at ambient temperatures and thus make them difficult to use.

This problem is believed to be due to the fact that when the agricultural compounds are a small particle size, they tend to naturally pack closely together, and therefore there is less space available into which to compress the material. Secondly, the small particles tend to clump together when compressed under high pressure, and upon decompression, such as mixing with water, to decompress into larger agglomerated particles than were present before compression. This results in poor suspensibility of the material when mixed with water, poor foliar coverage, and potential clogging of nozzles found in spray equipment. The addition of surfactants to the formula, while necessary for wetting and a proper dispersion in water, can of and by themselves be insufficient to break up the agglomerated particles resulting from compression.

It would be advantageous to provide tablet forms of agricultural products, so that contact with the agents in tablet form can be minimized. It would be advantageous to provide new tablet forms of agricultural chemicals that disperse rapidly in aqueous solutions, and methods of making and using the tablets. The present invention provides such tablets and methods.

### SUMMARY OF THE INVENTION

Tablets which include agricultural compounds, and which can be readily dispersed in aqueous media, are disclosed. The tablets include small amounts of microcrystalline cellulose (CAS#9004-34-6), such as the products Lattice NT, Avicel and Endurance. Microcrystalline cellulose is known to display both binder and disintegrate properties, but in this application it is also acting as a dispersant. It is the total quantity of the MCC in the formula that determines the speed of disintegration, but it is the relative sizes of the agricultural compound and MCC particles that determine the dispersion characteristics.

The agricultural compounds can be hydrophilic, hydrophobic, or amphiphilic, and can be plant growth regulators, pesticides, nutrients, and the like. The pesticide may be a herbicide such as atrazine, simazine, cyanazine, terbuthylazine, diuron, chlorsulphuron, metsulfuron, tralkoxydin, or 2-(2-chloro-4-mesylbenzoyl)cyclohexane-1,3-dione; an insecticide such as deltamethrin, lindane, carbaryl, endosulfan, or carbofuran; a fungicide such as thiophanate methyl, carbendazim, flutriafol, hexaconazole, chlorothalonil, copper oxychloride, captan or thiram; or an acaricide such as hexythiazox, cyhexatin or amitraz.

The tablets are particularly useful with hydrophobic compounds, such as hydrophobic pesticides, of small particle size, which can be compressed into a stable tablet and made to rapidly disintegrate back into fine particles when mixed with water.

The tablets can include optional components, such as wetting agents, surfactants absorptive carriers, binders, flow agents, tableting lubricants, antifoam agents, and fillers.

While not wishing to be bound to a particular theory, it is believed that the key is using microcrystalline cellulose that has a particle size as close as possible to the initial particle size of the agricultural compound. For this reason, it is preferred that the particle size of the agricultural compound and the microcrystalline cellulose are less than about 100 microns, more preferably, less than about 50 microns, and that the particle sizes of both the agricultural compound and the microcrystalline cellulose range from 1:5 to 5:1 more preferably between 1:3 and 3:1, and still more preferably, between 1:2 to 2:1.

Using the technology described herein, the tablets can include up to 70 percent by weight of the agricultural compound. In one embodiment, the tablets include between 5 and 70% agricultural compound, preferably between 30 and 70% of agricultural compound, and a minor amount (ideally less than 25% by weight) of microcrystalline cellulose. The tablets can also include optional components, such as wetting agents/surfactants. In some embodiments, a blend of particle sizes for the microcrystalline cellulose, for example, a blend of 13 and 50-micron particles can be used. This embodiment tends to produce a mix that flows better in a tablet press and reduces the cost of production.

In order to prevent the dispersion from clogging sprayers the size of the suspended materials should be less than 150 microns. Accordingly, the particle size of the agricultural compound and the MCC (taking into consideration any swelling of the particles that would occur in aqueous solution) should be less than about 150 microns.

The particle size of the agricultural compound is preferably less than about 20 microns, and more preferably, less than about 10 microns. The particle size of the microcrystalline cellulose is preferably less than about 100 microns, more preferably, less than about 50 microns. Tablets prepared using 50-micron microcrystalline cellulose tend to compress better than those in which the particle size is less than about 20 microns (such as, for example, 13 microns). However, the total quantity of MCC used does not have to be of a particle size similar to the AI in order to achieve good dispersion. For examples, in a tablet formula that contains 70% of AI and the AI has a mean particle size of less that 10 microns, as little as 3-5% by weight of the smaller particle sizes of microcrystalline cellulose are enough to provide a tablet that disintegrates into fine particles when mixed with water although additional MCC of any size is needed to produce a rapid disintegration. The resulting tablets disperses rapidly in water and do not clog sprayers.

While it can be preferred to have a total of about 20% MCC in the tablet in order to (a) bind the material into a good tablet and, (b) disintegrate in the desired time frame of between about two and five minutes when placed in aqueous solution, not all of the MCC has to have the smallest particle size (for example, about 13 microns).

For example, tablets loaded with up to 70% agricultural chemicals can include as little as about 5%, or even less, of the relatively small (i.e., 13-micron) MCC, and about 15 percent of relatively larger (i.e., 50 to 100 micron) MCC and get essentially the same rate of disintegration, or even higher, and fine dispersion as those achieved using 20% of relatively small (13-micron) MCC.

The tablets can be prepared by mixing the particles of microcrystalline cellulose and agricultural compound, along with any desired optional adjuvants and excipients, and compressing the blend of particles. It is preferred that the portion of microcrystalline cellulose with the smallest particle size be blended directly with the agricultural compound before any other adjuvants are added to the blend. Slugging via direct compression is a preferred method of tableting as it tends to keep costs down, but other routes, such as wet granulation, can be used. It is also preferred that the tablets are formed at or below room temperature, since the particles may agglomerate if warmed up above the melting point of the microcrystalline cellulose or agricultural compound. Thus, the tablets can be prepared by mixing at least one active agricultural ingredient which is in solid form at room temperature, and which has an average particle size of less than 25 microns, with a particulate microcrystalline cellulose and any optional components, to provide a compressible mix; and compressing the mix into tablet form.

The size of the tablets can vary, depending on the amount of agricultural compound needed, and the size of the “unit dose” that is being produced. The tablet size is not a critical value, in contrast to the size of the particles of agricultural compound and MCC, in determining the tablets performance. For example, tablets have been produced in the range of 0.1 g to 28.3 g (1 ounce) and producing tablets of 4 to 8 ounces should be feasible. As the size of the tablets is increased the total disintegration time will also increase although even large tablets in the range of 1 ounce can be made to disintegrate in less than 5 minutes.

The tablets can be included in blister packages, which can help minimize physical contact with the agricultural compounds. They can also be coated, which will reduce friability and also minimize physical contact.

### DETAILED DESCRIPTION OF THE INVENTION

The tablets, individual components used to prepare the tablets, and methods for their preparation and use thereof, are described in more detail below.

I. Tablet Components

The tablets include one or more agricultural compounds, one or more types of microcrystalline cellulose, optionally with more than one particle size range, and various optional components such as those present in conventional tablets.

Suitable tablets generally contain up to about 70% by weight of agricultural compound, based on the total weight of the tablet, and it is generally desirable for the tablets to include a high percentage of the agricultural compound. The tablets will also generally contain from about 3-20% by weight of the MCC particles, more preferably about 5-20% by weight, based on the total weight of the tablet.

The tablets can also contain suitable excipients such as dry binders and/or compression aids; and other excipients in amounts of up to about 20% by weight.

The individual components are described in more detail below.

Agricultural Chemicals

The agricultural compounds are solid materials with a melting point greater than room temperature, preferably greater than about 55° C., more preferably greater than about 70° C. If the melting point is less than this range, the compounds can melt during processing and agglomerate, thus inhibiting the ability of the tablet composition to disperse rapidly in aqueous media. The compounds can be hydrophobic, hydrophilic, or amphiphilic, although compounds which are hydrophobic or amphiphilic are preferred.

As used herein, a hydrophobic compound has a water solubility of less than 1000 mg/l at 25° C., preferably less than 50 mg/l at 25° C. As used herein, a hydrophilic compound has a water solubility of greater than 1000 mg/l at 25° C., preferably more than 10 g/l at 25° C. Amphiphilic molecules have a polar, water-soluble group attached to a nonpolar, water-insoluble hydrocarbon chain. Such molecules typically have a solubility in aqueous and non-aqueous solvents of greater than 1000 mg/l at 25° C., preferably more than 10 g/l at 25° C. In one embodiment, the agricultural is hydrophobic.

Truly hydrophilic compounds may be dissolved fairly readily in aqueous media without the need for the instant tablet forms, although the tablet forms can stabilize the compounds and keep them from degrading on long term storage, and provide the safety and convenience of a unit dose including the tablet forms.

Any type of agricultural chemical, pesticide or genetic material, which results in a desired effect on a plant can be used. The active components can be herbicidal, pesticidal, insecticidal, bactericidal, virucidal, fungicidal, acaricidal, and the like. The active components can be genetic material to be transfected into a plant.

Any pesticide that causes the desired result can be used. A pesticide is defined by the Federal Government in 40 CFR 152.3 as “any substance (or group of structurally similar substances if specified by the Agency) that will prevent, destroy, repel, or mitigate any pest, or that functions as a plant regulator, desiccant or defoliant within the meaning of FIFRA sec. 2 (a).” Any compound that regulates plant growth can be included in the compositions of the invention. Examples of the plant-growth regulator include defoliators and desiccants.

Any herbicide that causes the desired result can be used. Herbicides are generally broken down into broad categories, including pre-plant herbicides, burndown herbicides, and post-emergence herbicides. Those of skill in the art of farming know when it is appropriate to use a particular type of herbicide.

Any insecticide that is effective against a particular insect to be eliminated from a particular crop or site can be used.

Any bactericide, fungicide or virucide that is effective at a particular bacteria, fungus or virus can be incorporated into the compositions described herein and applied to a desired crop or situs.

Any suitable acaracide can be used.

The agricultural compounds can be sparingly soluble in water, with water hence being the carrier liquid for use in forming the suspension concentrate and the concentration of the pesticide in the water, in the suspension concentrate, thus being greater than the solubility limit of the pesticide in water.

Preferably, the pesticide and the microcrystalline cellulose should both have a melting point exceeding about 55° C., preferably more than about 70° C. If the melting points are less than this range, the compounds and/or cellulose can melt during processing and agglomerate, thus inhibiting the ability of the tablet composition to disperse rapidly in aqueous media.

Representative agricultural compounds suitable for use in the tablet forms of the invention include, but are not limited to, atrazine, simazine, cyanazine, terbuthylazine, diuron, chlorsulphuron, metsulfuron, or tralkoxydim; an insecticide such as deltamethrin, acetamiprid, lindane, carbaryl, endosulfan, or carbofuran; a fungicide such as thiophanate methyl, Maneb, Mancozeb, carbendazim, flutriafol, hexaconazole, chlorothalonil, copper oxychloride, captan or thiram; or an acaricide such as hexythiazox, dicofol, cyhexatin or amitraz.

Microcrystalline Cellulose

MCC is a common excipient for pharmaceutical and veterinary tablets. It is a purified, partially depolymerized cellulose that is produced by treating a source of cellulose, preferably alpha cellulose in the form of a pulp from fibrous plants, with a mineral acid, such as hydrochloric acid. The acid selectively attacks the less ordered regions of the cellulose polymer chain, thereby exposing and freeing the crystallite sites, thereby forming the crystallite aggregates that constitute MCC. The aggregates are then separated from the reaction mixture and washed to remove degraded by-products. The resulting wet mass, generally containing 40 to 60 percent moisture, is referred to in the art by several names, including hydrolyzed cellulose, MCC, microcrystalline cellulose wet cake, or simply wet cake. It is this hydrolyzed cellulose, which may be further modified, for example, by attrition or spray drying, that is utilized as the starting material for the tablets of the present invention. Any MCC that is within the desired size range can be used. Examples of suitable MCC that are commercially available include Lattice NT, Avicel and Endurance.

Optional Components

Additional optional components that can be present in the composition include adjuvants currently used with agricultural chemicals, such as, buffering agents, antifoam agents, compatibility agents, fillers, carriers, dispersants, drift control agents, penetrants, surfactants, spreaders, and wetting agents. Additional components that are more specific to tablet manufacturer, such as lubricants and flow agents can also be used.

The other excipients may include an additional disintegrant in an amount of 0-10% by weight, more preferably 0-5% by weight, and most preferably 0-2% by weight, based on the total weight of the tablet, and one or more lubricants. Conventional lubricants such as magnesium stearate, stearic acid and hydrogenated vegetable oil may be employed in conventional amounts of about 0.1-10% by weight, based on the total weight of the tablet to prevent or inhibit the tablets from sticking to the apparatus used to compress the materials into a tablet. Other excipients may also include conventional glidants, which are employed to improve the flowability of the powders to facilitate handling of the materials during the tableting operation. Typical glidants include talc, and silicas such as fumed silica and precipitated silica.

Flow Agents

Any flow agent that is able to minimize or prevent the feed material from caking or clogging in the production feed mechanisms and hopper can be used, typically in amounts of between 0.1% and 2%. Examples of suitable flow agents include silica gels; both fumed and precipitated and clays such as kaolin, talc, diatomaceous earth.

Fillers

Fillers are added to dilute the final production feed material blend to the desired concentration of the agricultural compound. Examples of suitable fillers include clays such as kaolin and Montrnorillite, talc, and diatomaceous earth.

Tablet Lubricants

Lubricating agents may be added to the formula in order to reduce friction and binding of the tablets when being compressed and ejected from a tablet press. Lubricants are usually added to the formula in amounts of between 0.1% and 1.0%. Examples of suitable lubricants are magnesium state and hydrogenated vegetable oil.

Dosage Devices

The tablets can be included in dosage devices, such as blister packages. The tablets can be produced in bisected or multisected form so that they can be subdivided by hand or machine for delivery of fractional amounts of the agricultural compounds. Such tablets are particularly useful for delivery of pesticides, herbicides and other agricultural chemicals for home and garden, green house, forestry, and farm markets without significantly compromising bioefficacy.

II. Methods of Making the Tablets

The tablets can be prepared by mixing/blending the particles of microcrystalline cellulose and the agricultural compound, along with any desired optional excipients, and tableting the blend of particles. It is preferred that the microcrystalline cellulose be blended directly with the agricultural compound before any other adjuvants are added to the blend.

Blending techniques are well known and include dry blending or granulation, wet granulation followed by oven drying, and aqueous dispersion followed by spray drying. Tablets can be formed from the blend using any of the known compacting processes, including direct compression and roller compaction of dry blends, wet granulation followed by compaction, and spheronization. The selection of method can depend on the active agent, the ability of the agricultural compound to flow freely in the tabletting machine or extruder, and the cohesiveness of the ingredients. If the mixture is a free-flowing powder, it can be directly compressed. Direct compression, for example, by slugging, is a preferred method of tableting. Other routes, such as wet granulation, can provide some benefits, albeit at a higher manufacturing cost.

In dry granulation, a dry powdery blend of the components is compressed to form slugs if a tablet press is used. Alternatively, the dry blend is roller compacted to form sheets. The slugs or sheets are then sieved to form granules for final tableting or a roller compactor with a suitable roller set may be used to produce tablets, or briquettes, directly.

In wet granulation, water is added to a mixture of the MCC and the agricultural compound, and any optional components, to form a wet, granular material. The amount of water depends on the ratio of the MCC and the compound. The wet, granular material is then screened, dried, and then screened again. The resulting granules are then ready for tableting.

In one embodiment, the tablets are prepared by mixing at least one active agricultural ingredient which is in solid form at room temperature, and which has an average particle size of less than 25 microns, with a particulate microcrystalline cellulose and any optional components, to provide a compressible mix; and compressing the mix into tablet form. The mixing of the MCC and the agricultural compounds should be adjusted to result in a final mixture having desired characteristics for tableting. The mixing step should be shortened if the density of the final, dried material begins to increase significantly.

It can be preferred that the tablets are formed at or below room temperature, or at least below the melting point of the agricultural compound and the microcrystalline cellulose, since the particles may agglomerate if warmed up above the melting point of the microcrystalline cellulose or agricultural compound.

The size of the tablets can vary, depending on the amount of agricultural compound needed, and the size of the “unit dose” that is being produced. The tablet size is not a critical value, in contrast to the size of the particles of agricultural compound and MCC, in determining the tablets performance. For example, tablets have been produced in the range of 0.1 g to 28.3 g (1 ounce) and tablets in the size range of about 4 to about 6 ounces can be prepared. As the size of the tablets is increased, the total disintegration time will also increase, although even large tablets in the range of 1 ounce can be made to disintegrate in less than 5 minutes.

III. Methods of Using the Tablets

The tablets are generally dissolved or dispersed in aqueous solutions to form solutions or dispersions including the agricultural compounds. The particle size of the individual components is less than about 150 microns under conditions of use (i.e., at the temperature and time following disintegration of the tablet when placed in an aqueous solution). The resulting solution or dispersion is then applied to a plant or treatment locus in need of treatment thereof in an effective amount to effect such treatment. The compositions can be applied by conventional application techniques. These techniques include, but are not limited to, foliar administration, root application, drip application, leaf application, aerial spraying, spray application, and the like.

In practice, the tablets are ideally introduced into a predetermined volume of water or aqueous solvent, allowed to disintegrate over a period of about one to five minutes to form a solution or dispersion of the agricultural compound in the water; and the solution or dispersion is then applied to an article or locus to be treated.

Pest Control

In one embodiment, the tablets include a pesticide, herbicide, insecticide, fungicide, virucide, bacteriocide, and/or acaricide, and are used to provide pest control to an individual plant or a locus. The methods involve applying to the plant or locus an effective pesticidal, herbicidal, insecticidal, fungicidal, virucidal, bacteriocidal, and/or acaricidal amount of a composition including a permeabilizing agent and a pesticide, herbicide, insecticide, fungicide, virucide, bacteriocide, and/or acaricide.

Weed Control

The tablets can also be used in weed control applications. Weed control essentially involves applying a compound that selectively controls one type of plant in the presence of another. Examples include crabgrass-selective compounds that have little or no effect on grass.

The present invention will be better understood with reference to the following non-limiting examples:

### EXAMPLE 1

### Representative Tablet Formulation

In this example, a representative formulation for preparing the tablets described herein is provided. This formulation includes 70% of the agricultural compound, which is a relatively high loading. This formulation can be used, however, with lower loadings of the active compounds by making up the balance of the weight with appropriate excipients.

Formulation I

Active Agricultural Compound—70%

Dispersing agents—9%

Fatty acid salt-based lubricant—1.3%

Surfactant—2.1%

MCC—17.2%

Wetting agent—0.1%

The formulations to be tableted can include one size of MCC, or more than one size of MCC, as outlined in the following formulations:

Formulation II

| | |
|---|---|
| Agricultural Compound - | 70% |
| Dispersing agent(s) - | 7% |
| Fatty acid salt-based lubricant - | 1% |
| Surfactant - | 2% |
| MCC (13 micron) - | 20% |

Formulation III

| | |
|---|---|
| Agricultural Compound - | 70% |
| Dispersing agent(s) - | 7% |
| Fatty acid salt-based lubricant - | 1% |
| Surfactant - | 2% |
| MCC 100 micron- | 15% |
| MCC (13 micron) - | 5% |

The smaller particle size MCC material is typically more expensive and flows less well in a tableting press. Therefore, it is desirable to use as little of the 13-micron material as possible.

Although the present invention has been described with reference to preferred embodiments, those skilled in the art will recognize that changes may be made in form and detail without departing from the spirit and scope of the invention.

1. A tablet comprising one or more agricultural compounds and microcrystalline cellulose, wherein:
a) the particle size of the agricultural compound(s) and microcrystalline cellulose are less than about 100 microns,
b) the ratio of particle size between the agricultural compound(s) and at least a portion of the microcrystalline cellulose ranges between 1:5 and 5:1, and
c) the tablet, when added to an aqueous solution, disperses within five minutes to form a solution or dispersion,
wherein the particle size of one or both of the microcrystalline cellulose and agricultural compound in the solution or dispersion are approximately the same as the particle size of that component in the tablet itself would be when added directly to the aqueous solution.

2. The tablet of claim 1, wherein the agricultural compound is hydrophobic.

3. The tablet of claim 1, wherein the agricultural compound is solid at room temperature.

4. The tablet of claim 1, wherein the agricultural compound is selected from the group consisting of plant growth regulators, pesticides, nutrients, bactericides, fungicides, acaricides, and virucides which are solid at room temperature.

5. The tablet of claim 1, wherein the agricultural compound is selected from the group consisting of atrazine, simazine, cyanazine, terbuthylazine, diuron, chlorsulphuron, metsulfuron, tralkoxydin, or 2-(2-chloro-4-mesylbenzoyl)cyclohexane-1,3-dione; an insecticide such as deltamethrin, lindane, carbaryl, endosulfan, or carbofuran; a fungicide such as thiophanate methyl, carbendazim, flutriafol, hexaconazole, chlorothalonil, copper oxychloride, captan or thiram; or an acaricide such as hexythiazox, cyhexatin and amitraz.

6. The tablet of claim 1, wherein the particle size of the microcrystalline cellulose is less than 50 microns.

7. The tablet of claim 1, wherein the microcrystalline cellulose has a combination of particle size ranges, with one size range of between about 50 and 100 microns and the other between about 5 and 20 microns.

8. The tablet of claim 1, where the agricultural compound is present in the tablet in an amount ranging from about 5 to about 70 percent by weight of the tablet.

9. The tablet of claim 1, where the microcrystalline cellulose is present in the tablet in an amount ranging from about 3 to about 25 percent by weight of the tablet.

10. The tablet of claim 1, wherein the ratio of particle size between the agricultural compound(s) and at least a portion of the microcrystalline cellulose ranges between 1:3 and 3:1.

11. The tablet of claim 1, wherein the ratio of particle size between the agricultural compound(s) and at least a portion of the microcrystalline cellulose ranges between 1:2 and 2:1.
